(19) United States
(12) Patent Application Publication
(10) Pub. No.: US 2026/0012809 A1
(43) Pub. Date: Jan. 8, 2026

(54) SYSTEM AND METHOD FOR INDOOR AND OUTDOOR BENCHMARKING IN TELECOM

(71) Applicant: JIO PLATFORMS LIMITED, Ahmedabad (IN)

(72) Inventors: Aayush BHATNAGAR, Navi Mumbai (IN); Pradeep Kumar BHATNAGAR, Navi Mumbai (IN); Sundaresh SANKARAN, Mumbai (IN); Haresh B AMBALIYA, Bhundani (IN); Rahul SINGH, Murwara (IN); Pooja BAIRAGI, Indore (IN); Uday VERMA, Shivpuri (IN); Anmol NEEMA, Indore (IN); Rohit MALVIYA, Thane (IN)

(73) Assignee: JIO PLATFORMS LIMITED, Ahmedabad (IN)

(21) Appl. No.: 18/992,300

(22) PCT Filed: May 24, 2024
(86) PCT No.: PCT/IN2024/050607

§ 371 Date: Jan. 8, 2025

(30) Foreign Application Priority Data
Jun. 30, 2023 (IN) 202321043898

(51) Int. Cl. H04W 16/20

(52) U.S. Cl. CPC H04W 16/20

(57) ABSTRACT

The present disclosure provides system and method for indoor and outdoor benchmarking in telecom. The system includes a master handset and one or more slave handsets, connected through wireless technology such as Bluetooth or Wi-Fi, where the master handset creates a floor plan of the user premises and performs all measurements. The system generates a single benchmark report for all operators, saving time, costs, and engineer efforts. The report can be visualized on the survey dashboard, providing a comprehensive view of operators' network performance.

### FIELD OF INVENTION

The present disclosure relates generally to a field of telecommunications technology in building benchmarking for wireless networks. In particular, the present disclosure pertains to a system and a method for indoor and outdoor benchmarking in telecom.

### BACKGROUND

Wireless networks have become an integral part of our daily lives, and the demand for high-speed data connectivity is constantly increasing. With the exponential growth in the use of mobile devices, the need for reliable and efficient wireless networks is more important than ever. However, it is often observed that indoor wireless coverage is not as strong as outdoor coverage, which can lead to poor quality of service, slow data transfer rates, and dropped calls. This is particularly problematic in buildings with thick walls, multiple floors, and complex layouts, where wireless signals can be obstructed or weakened.

To address these issues, telecom companies have been deploying in-building wireless solutions, such as Distributed Antenna Systems (DAS) and Small Cells. These solutions work by distributing the wireless signal throughout the building, using a network of antennas and amplifiers. However, deploying these solutions can be time-consuming and expensive, and it is often difficult to measure their effectiveness. In addition, there is a need for ongoing monitoring and optimization of the in-building wireless network, to ensure that it meets the needs of the users.

One approach to measuring the effectiveness of an in-building wireless network is benchmarking. Benchmarking involves collecting data on key performance indicators (KPIs), such as signal strength, data transfer rates, and call quality, and comparing them to industry standards or best practices. This can help identify areas of the network that need improvement and provide a basis for ongoing monitoring and optimization.

However, traditional benchmarking methods are often manual and time-consuming, requiring technicians to walk through the building with specialized equipment and take measurements at various locations. This can be costly and disruptive and may not provide a comprehensive view of the network performance. In addition, traditional benchmarking methods do not provide real-time monitoring, making it difficult to identify and resolve issues as they arise.

To address these challenges, there is a need for a system and method for indoor and outdoor benchmarking that is automated, efficient, and provides real-time monitoring.

### SUMMARY

An exemplary embodiment describes a method for indoor or outdoor benchmarking in a telecommunication network. The method comprises connecting a master device to a plurality of slave devices using a wireless technology. The master device connected to one of plurality of operators and each of the plurality of slave devices connected to one of remaining other operators of the plurality of operators. The method further comprises capturing, by the master device and each of the plurality of slave devices, a plurality of parameters for respective plurality of operators and sending, by the plurality of slave devices, the captured parameters of the respective operators to the master device. The method comprises syncing, by the master device, the captured parameters of the respective operators from the master device and the plurality of slave devices and sending, by the master device, all sync data to the backend server. The method comprises performing, by the backend server, a benchmark analysis and generating, by the backend server, a benchmark report for the plurality of operators.

In some embodiments, the method comprising, for capturing the parameters of respective plurality of operators in the indoor benchmarking, creating, by a user, a floor plan on the master device via an application programming interface (API). The method further comprises conducting, by the user, a walk test by selecting a location on the floor plan and capturing, by the master device and the plurality of slave devices, the plurality of parameters for respective plurality of operators for the selected location on the floor plan.

In some embodiments, the method comprises capturing the parameters of the respective plurality of operators in the outdoor benchmarking, starting, by the user, a driving test for an outdoor benchmarking from a first location to a second location on the master device via the API. A map of the drive test is shown on the master device. The method comprises capturing, by the master device and each of the plurality of slave devices, the plurality of parameters for respective plurality of operators. The method comprises when the user stops at the second location, receiving, by the master device, the plurality of measurements from the plurality of slave devices.

In some embodiments, the method comprises for performing the benchmark analysis, collecting, by the backend server, a plurality of samples of the captured parameters for each of the plurality of operators according to a plurality of defined ranges. The method further comprises calculating, by the backend server, average of all the samples of the captured parameters for each of the plurality of operators. The plurality of parameters includes a received signal reference power (RSRP), a signal to interference plus noise ratio (SINR), a throughput for uplink and downlink. The method comprises setting, by the backend server, a plurality of ranks to the samples of the captured parameters for each of the plurality of operators according to respective strengths. The plurality of ranks includes good, average and bad. The method comprises plotting, by the backend server, a graph of samples of the captured parameters for each of the plurality of operators according to the ranks and calculating, by the backend server, a performance score and a coverage score of each of the plurality of operators. The method comprises calculating, by the backend server, an overall rating of each of the plurality of operators and generating, by the backend server, the benchmark report for the plurality of operators.

In some embodiments, the benchmark report is visualized in a dashboard.

In another exemplary embodiment, a system for indoor or outdoor benchmarking in a telecommunication network is described. The system comprises a master device, a plurality of slave devices and a backend server. The system comprises connecting a master device to a plurality of slave devices using a wireless technology. The master device connected to one of plurality of operators and each of the plurality of slave devices connected to one of remaining other operators of the plurality of operators. The master device and each of the plurality of slave devices are configured to capture a plurality of parameters for a respective plurality of operators. The master device comprising a receiving module is configured to receive the captured parameters of the respective operators from the plurality of slave devices. A processing module is configured to sync the captured parameters of the respective operators from the master device and the plurality of slave devices. A sending module is configured to send all sync data to the backend server. The backend server comprises an analyzing module configured to perform a benchmark analysis. A generating module configured to generate a benchmark report for the plurality of operators.

In some embodiments, the system comprises, for capturing the parameters of respective plurality of operators in the indoor benchmarking, the master device configured to create a floor plan on the master device via an application programming interface (API). The master device configured to conduct a walk test by selecting a location on the floor plan. The master device and each of the plurality of slave devices are configured to capture the plurality of parameters for a respective plurality of operators for the selected location on the floor plan.

In some embodiments, the system comprises, for capturing the parameters of the respective plurality of operators in the outdoor benchmarking, the master device configured to start a driving test for an outdoor benchmarking from a first location to a second location on the master device via the API. A map of the drive test is shown on the master device. The master device and the plurality of slave devices configured to capture the plurality of parameters for respective plurality of operators. When the user stops at the second location, the master device is configured to receive the plurality of measurements from the plurality of slave devices.

In some embodiments, for performing the benchmark analysis, the backend server comprising a collection module configured to collect a plurality of samples of the captured parameters for each of the plurality of operators according to a plurality of defined ranges. The calculation module configured to calculate average of all the samples of the captured parameters for each of the plurality of operators. The plurality of parameters includes a received signal reference power (RSRP), a signal to interference plus noise ratio (SINR), a throughput for uplink and downlink. A processing module is configured to set a plurality of ranks to the samples of the captured parameters for each of the plurality of operators according to respective strengths. The plurality of ranks includes good, average and bad. The processing module is configured to plot a graph of samples of the captured parameters for each of the plurality of operators according to the ranks. The calculation module is configured to calculate a performance score and a coverage score of each of the plurality of operators. The calculation module is configured to calculate an overall rating of each of the plurality of operators. The generating module is configured to generate the benchmark report for the plurality of operators.

In some embodiments, the benchmark report is visualized in a dashboard.

In another exemplary embodiment, a master device for indoor or outdoor benchmarking in a telecommunication network is described. The master device configured to connect with the plurality of slave devices using a wireless technology. The master device is connected to one of the plurality of operators and each of the plurality of slave devices is connected to one of remaining other operators of the plurality of operators. The master device is configured to capture a plurality of parameters for the respective plurality of operators. Each of the plurality of slave devices configured to capture the plurality of parameters for the respective plurality of operators. The master device is configured to receive the captured parameters of the respective operators from the plurality of slave devices and sync the captured parameters of the respective operators from the master device and the plurality of slave devices. The master device and the plurality of slave devices are user equipments. The master device is configured to send all sync data to the backend server. The backend server configured to generate a benchmark report for the plurality of operators by performing a benchmark analysis.

In an embodiment, the master device for capturing the parameters of respective plurality of operators in the outdoor benchmarking further configured to create a floor plan via an application programming interface (API), conduct a walk test by selecting a location on the floor plan and capture the plurality of parameters for respective plurality of operators for the selected location on the floor plan. Each of the plurality of slave devices configured to capture the plurality of parameters for respective plurality of operators for the selected location on the floor plan.

In an embodiment, the master device for capturing the parameters of respective plurality of operators in the outdoor benchmarking further configured to start a drive test for the outdoor benchmarking from a first location to a second location via the API. The master device configured to show a map of the drive test. The master device configured to capture the plurality of parameters for the respective plurality of operators and receive a plurality of measurements from the plurality of slave devices when the user stops at the second location.

In an embodiment, for performing the benchmark analysis, the backend server is configured to collect a plurality of samples of the captured parameters for each of the plurality of operators according to a plurality of defined ranges. The backend server configured to calculate average of all the samples of the captured parameters for each of the plurality of operators. The plurality of parameters includes a received signal reference power (RSRP), a signal to interference plus noise ratio (SINR), a throughput for uplink and downlink. The backend server is configured to set a plurality of ranks to the samples of the captured parameters for each of the plurality of operators according to respective strengths. The plurality of ranks includes good, average and bad. The backend server configured to plot a graph of samples of the captured parameters for each of the plurality of operators according to the rank and calculate a performance score and a coverage score of each of the plurality of operators. The backend server is configured to calculate an overall rating of each of the plurality of operators and generate the benchmark report for the plurality of operators.

In an embodiment, the benchmark report is provided in a dashboard.

The foregoing general description of the illustrative embodiments and the following detailed description thereof are merely exemplary aspects of the teachings of this disclosure, and are not restrictive.

### OBJECTS OF THE PRESENT DISCLOSURE

Some of the objects of the present disclosure, which at least one embodiment herein satisfies are as listed herein below.

An object of the present disclosure is to provide an efficient and automated system for in-building benchmarking in the telecom industry that can measure the effectiveness of in-building wireless networks.

An object of the present disclosure is to develop a solution that can provide real-time monitoring of the in-building wireless network, enabling telecom companies to identify and address issues as they arise.

An object of the present disclosure is to reduce the cost and disruption associated with traditional benchmarking methods, such as manual measurement and specialized equipment.

An object of the present disclosure is to provide a comprehensive view of the network performance, enabling telecom companies to optimize network performance and meet the needs of users.

An object of the present disclosure is to develop a solution that is easy to deploy and use, utilizing wireless technology such as Bluetooth or Wi-Fi connectivity.

An object of the present disclosure is to provide a master-slave connectivity concept, where one handset will work as a master and others as slaves, connected through wireless technology, such as Bluetooth or Wi-Fi connectivity.

An object of the present disclosure is to utilize Bluetooth manager API and other modified Bluetooth socket connection APIs to enable communication between the master and slave handsets.

An object of the present disclosure is to provide an in-building survey benchmark solution that can be used to assess the effectiveness of in-building wireless networks and provide a basis for ongoing monitoring and optimization.

### BRIEF DESCRIPTION OF DRAWINGS

The accompanying drawings, which are incorporated herein, and constitute a part of this disclosure, illustrate exemplary embodiments of the disclosed methods and systems in which like reference numerals refer to the same parts throughout the different drawings. Components in the drawings are not necessarily to scale, emphasis instead being placed upon clearly illustrating the principles of the present disclosure. Some drawings may indicate the components using block diagrams and may not represent the internal circuitry of each component. It will be appreciated by those skilled in the art that disclosure of such drawings includes the disclosure of electrical components, electronic components or circuitry commonly used to implement such components.

FIG. 1A illustrates an exemplary network architecture, in accordance with an embodiment of the present disclosure.

FIG. 1B illustrates an exemplary block diagram of a master device, in accordance with an embodiment of the present disclosure.

FIG. 1C illustrates an exemplary block diagram of a backend server, in accordance with an embodiment of the present disclosure.

FIG. 1D illustrates an exemplary UI for application flow at in-building page and outdoor drive test, in accordance with an embodiment of the present disclosure.

FIG. 2 illustrates an exemplary UI for in-building and drive test benchmark solution (LTE+5G) application flow, in accordance with an embodiment of the present disclosure.

FIG. 3A illustrates an exemplary flow diagram of a method of generating a benchmark report, in accordance with an embodiment of the present disclosure.

FIG. 3B illustrates an exemplary flow diagram of a method for indoor or outdoor benchmarking in a telecommunication network, in accordance with an embodiment of the present disclosure.

FIG. 4A-4B illustrates exemplary graphs for LTE coverage, in accordance with an embodiment of the present disclosure.

FIG. 5A-5B illustrates exemplary graphs for LTE quality and throughput, and 5G network performance, in accordance with an embodiment of the present disclosure.

FIG. 6A-6B illustrates exemplary graphs for LTE+5G network performance, in accordance with an embodiment of the present disclosure.

FIG. 7A-7B illustrates exemplary graphs for overall rating, in accordance with an embodiment of the present disclosure.

FIG. 8 illustrates an exemplary computer system in which or with which embodiments of the present disclosure can be implemented, in accordance with an embodiment of the present disclosure.

The foregoing shall be more apparent from the following more detailed description of the disclosure.

### DETAILED DESCRIPTION OF DISCLOSURE

In the following description, for the purposes of explanation, various specific details are set forth in order to provide a thorough understanding of embodiments of the present disclosure. It will be apparent, however, that embodiments of the present disclosure may be practiced without these specific details. Several features described hereafter can each be used independently of one another or with any combination of other features. An individual feature may not address all of the problems discussed above or might address only some of the problems discussed above. Some of the problems discussed above might not be fully addressed by any of the features described herein.

The ensuing description provides exemplary embodiments only, and is not intended to limit the scope, applicability, or configuration of the disclosure. Rather, the ensuing description of the exemplary embodiments will provide those skilled in the art with an enabling description for implementing an exemplary embodiment. It should be understood that various changes may be made in the function and arrangement of elements without departing from the spirit and scope of the disclosure as set forth.

Specific details are given in the following description to provide a thorough understanding of the embodiments. However, it will be understood by one of ordinary skill in the art that the embodiments may be practiced without these specific details. For example, circuits, systems, networks, processes, and other components may be shown as components in block diagram form in order not to obscure the embodiments in unnecessary detail. In other instances, well-known circuits, processes, algorithms, structures, and techniques may be shown without unnecessary detail in order to avoid obscuring the embodiments.

Also, it is noted that individual embodiments may be described as a process which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed but could have additional steps not included in a figure. A process may correspond to a method, a function, a procedure, a subroutine, a subprogram, etc. When a process corresponds to a function, its termination can correspond to a return of the function to the calling function or the main function.

The word “exemplary” and/or “demonstrative” is used herein to mean serving as an example, instance, or illustration. For the avoidance of doubt, the subject matter disclosed herein is not limited by such examples. In addition, any aspect or design described herein as “exemplary” and/or “demonstrative” is not necessarily to be construed as preferred or advantageous over other aspects or designs, nor is it meant to preclude equivalent exemplary structures and techniques known to those of ordinary skill in the art. Furthermore, to the extent that the terms “includes,” “has,” “contains,” and other similar words are used in either the detailed description or the claims, such terms are intended to be inclusive—in a manner similar to the term “comprising” as an open transition word-without precluding any additional or other elements.

Reference throughout this specification to “one embodiment” or “an embodiment” or “an instance” or “one instance” means that a particular feature, structure, or characteristic described in connection with the embodiment is included in at least one embodiment of the present disclosure. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items.

The present disclosure relates generally to telecommunications technology in building benchmarking for wireless networks. In particular, the present disclosure pertains to a system and a method for indoor and outdoor benchmarking in telecom. The system enables telecom companies to quickly and easily measure the effectiveness of in-building wireless networks, identify areas for improvement, and optimize network performance. Thus, users have access to reliable and efficient wireless connectivity, both indoors and outdoors, and thereby help meeting the growing demand for high-speed data transfer rates and reliable call quality.

In an embodiment, the system includes a master handset and one or more slave handsets, which are connected through wireless technology such as Bluetooth or Wi-Fi. The master handset creates a floor plan of the user premises and performs all measurements, and the slave handsets capture technical parameters for respective telecom operators based on their locations. After the survey or drive test is complete, all slave measurements are synced with the master handset for heatmap and benchmarking analysis.

In an embodiment, a user conducts a walk test by clicking on locations on the floor plan on the master handset, and with every click, technical parameters are captured by both the master and slave handsets for multiple operators at the same time and location, enabling better benchmarking and analysis.

In an embodiment, the system is applicable to 2G, 3G, 4G, 5G, 6G, and beyond all generations of mobile technology with multiple bands and carriers of telecom operators.

In an embodiment, the system utilizes Bluetooth manager API and other modified Bluetooth socket connection APIs to enable communication between the master and slave handsets.

In an embodiment, the master handset works as master and other handsets work as slaves, which are connected through wireless technology such as Bluetooth or Wi-Fi connectivity.

In an embodiment, the system provides real-time monitoring of the in-building and outdoor wireless network, enabling telecom companies to identify and address issues as they arise.

In an embodiment, the system provides a comprehensive view of the network performance, enabling telecom companies to optimize network performance and meet the needs of users.

In an embodiment, the system provides an efficient and automated solution for in-building and outdoor survey benchmarking in telecom, reducing the cost and disruption associated with traditional benchmarking methods.

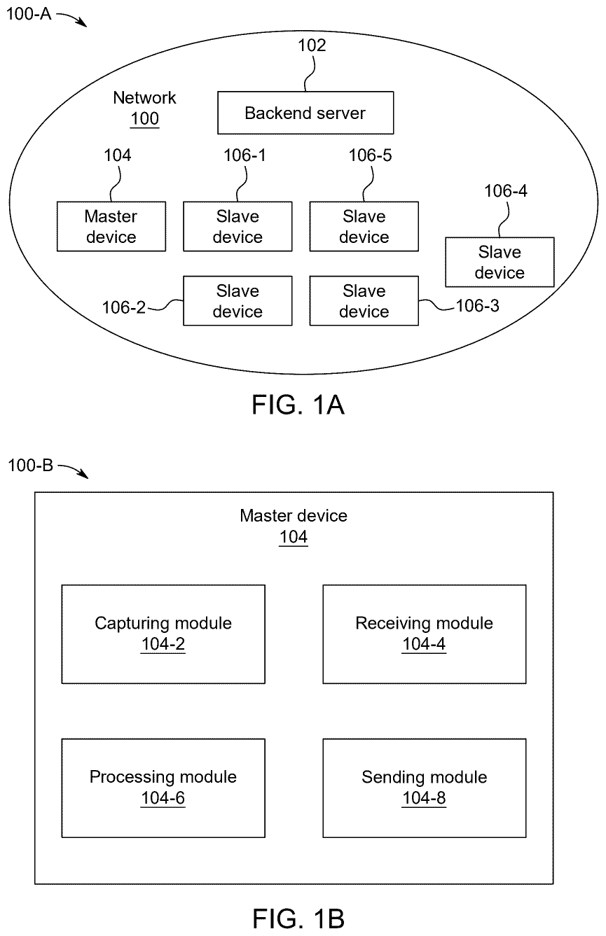

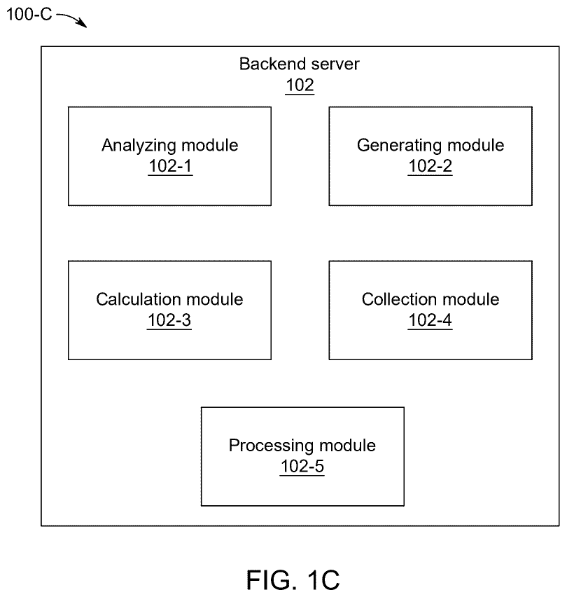

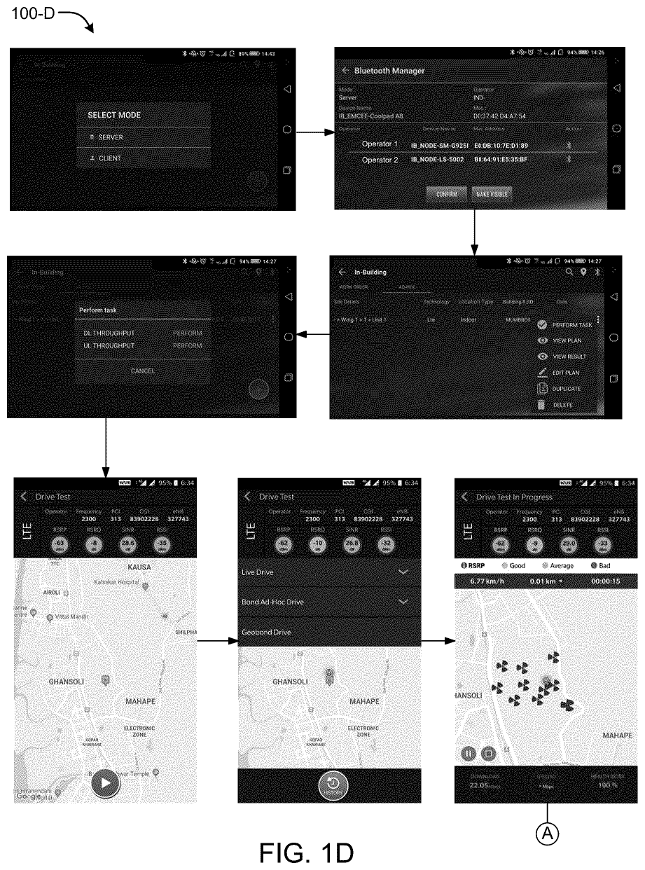

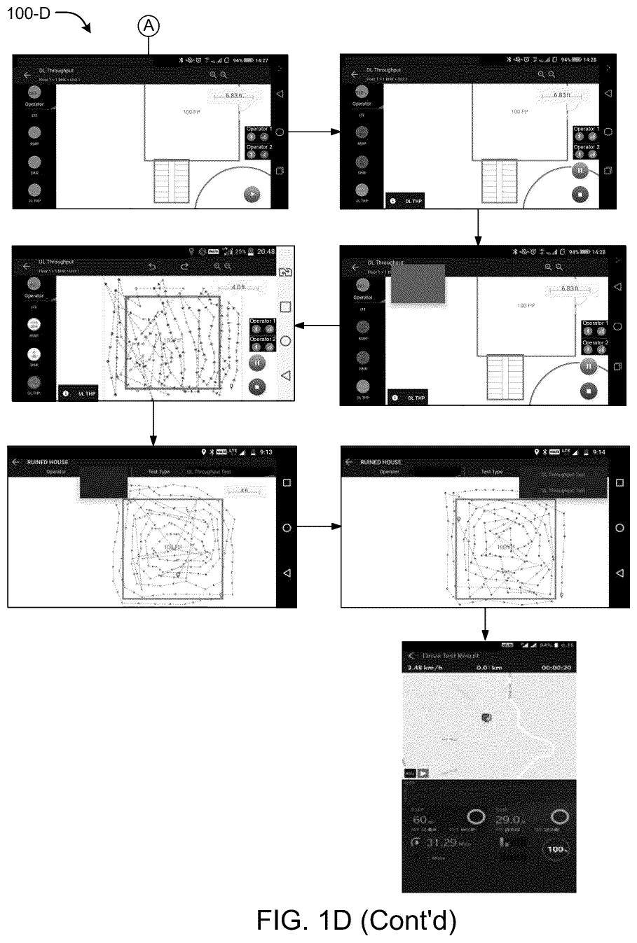

The various embodiments of the present disclosure are explained in more detail with reference to FIGS. 1-8

FIG. 1A illustrates an exemplary network architecture (100-A), in accordance with an embodiment of the present disclosure. The network architecture (100) includes a backend server (102), a master device (104), and a plurality of slave devices (106-1, 106-2, 106-3, 106-4, 106-5). The backend server (102) may be in communication with the master device (104) and the plurality of slave devices (106-1, 106-2, 106-3, 106-4, 106-5). The master device (104) may further communicate with the plurality of slave devices (106-1, 106-2, 106-3, 106-4, 106-5).

FIG. 1B illustrates an exemplary block diagram (100-B) of the master device (104), in accordance with an embodiment of the present disclosure. The master device (104) includes a capturing module (104-2), a receiving module (104-4), a processing module (104-6) and a sending module (104-8). The capturing module (104-2) is configured to capture a plurality of parameters from the respective plurality of operators. The receiving module (104-4) is configured to receive the captured parameters from the respective operators through the plurality of slave devices (106-1, 106-2, 106-3, 106-4, 106-5). The processing module (104-6) is configured to sync the captured parameters of the respective operators from the master device (104) and the plurality of slave devices (106-1, 106-2, 106-3, 106-4, 106-5). The sending module (104-8) is configured to send the data to the backend server (102).

FIG. 1C illustrates an exemplary block diagram (100-C) of the backend server (102), in accordance with an embodiment of the present disclosure. The backend server (102) includes an analyzing module (102-1), a generating module (102-2), a calculation module (102-3), a collection module (102-4), and a processing module (102-5). The analyzing module (102-1) is configured to perform a benchmark analysis. The generating module (102-2) is configured to generate a benchmark report for the plurality of operators. The benchmark analysis may be defined as a process of measuring and analysing the performance of different network operators. The benchmark analysis provides the operator as to how their network is performing in relation to its peers. The collection module (102-4) is configured to collect a plurality of samples of the captured parameters for each of the plurality of operators according to a plurality of defined ranges. The calculation module (102-3) is configured to calculate average of all the samples of the captured parameters for each of the plurality of operators. The plurality of parameters includes a received signal reference power (RSRP), a signal to interference plus noise ratio (SINR), and a throughput for uplink and downlink.

The processing module (102-5) is configured to set a plurality of ranks to the samples of the captured parameters for each of the plurality of operators according to respective strengths. The plurality of ranks includes good, average and bad. The processing module (102-5) is further configured to plot a graph of samples of the captured parameters for each of the plurality of operators according to the ranks. The calculation module (102-3) is configured to calculate performance and coverage scores of each of the plurality of operators. The calculation module (102-3) is further configured to calculate overall rating of each of the plurality of operators. The generating module (102-2) is configured to generate the benchmark report for the plurality of operators.

FIG. 1D illustrates an exemplary UI for application flow (100-D) at in-building page and outdoor drive test, in accordance with an embodiment of the present disclosure.

The user may perform in-building page and outdoor drive test via an application programming interface (API). The user can select connection mode by a click on Bluetooth manager option on the UI. At server, the master Device (104), different clients (e.g., slave devices (106)) can be connected by mutual pairing.

At in-building page, the user sees different options and can perform two tests i.e., download (DL) and upload (UL) throughput. This is for in-building indoor survey test.

For outdoor drive test, the user can start test by clicking over play button on the UI. Icons light up (i.e., Bluetooth & warming up icons).

The user can further see connected operators list when click over operators' icon. A test is performed by putting push pins. A user can pause and stop the test.

At result page, the user can see different operators walk test.

The drive result is displayed on the UI.

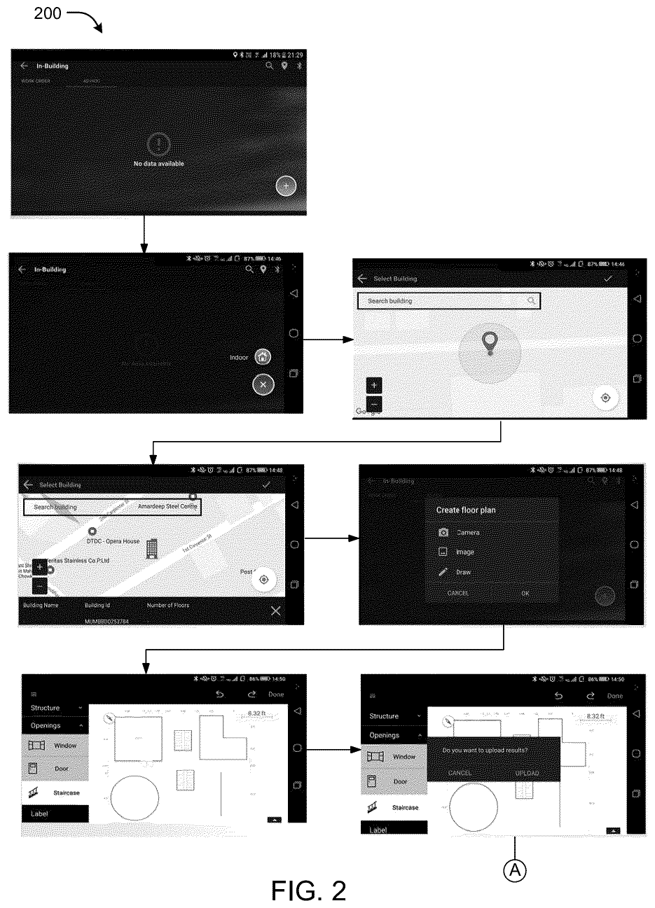

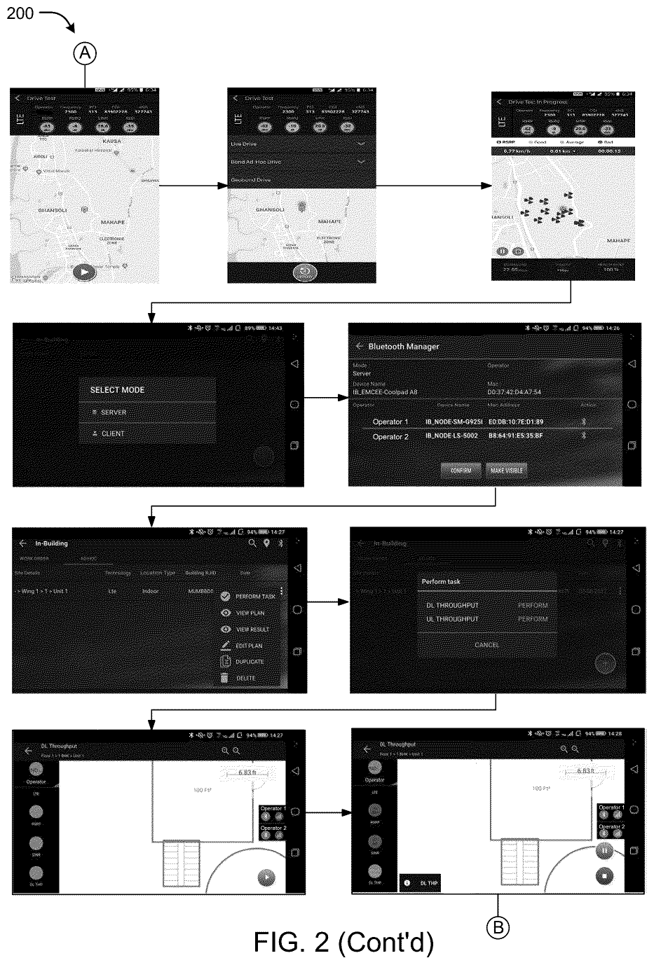

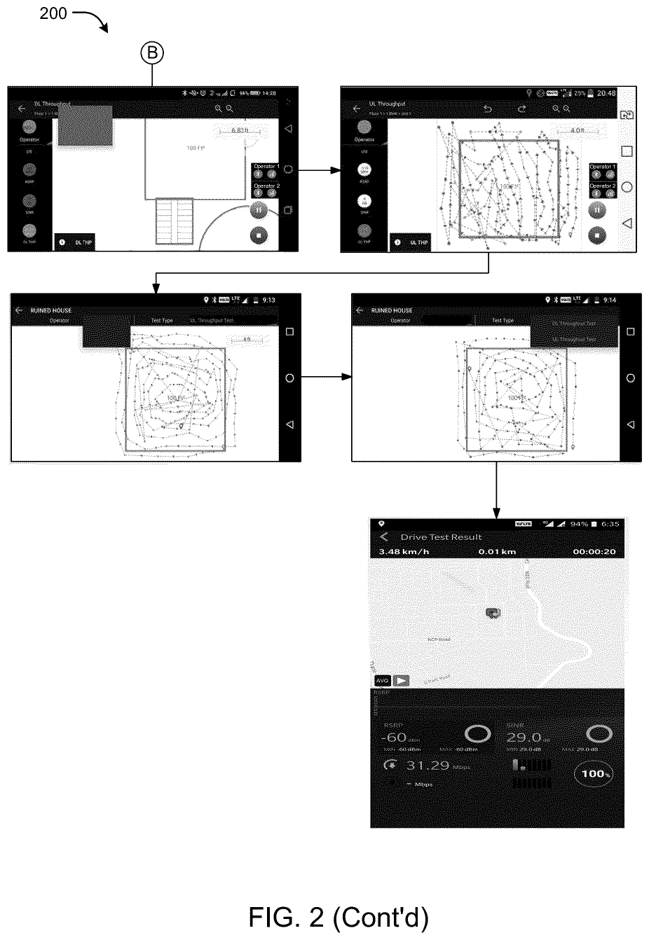

FIG. 2 illustrates an exemplary UI for in-building and drive test benchmark solution (LTE+5G) application flow (200), in accordance with an embodiment of the present disclosure.

When the user enters in in-building module and clicks over ‘+’ then indoor test option will appear and then it will redirect to select building page.

The user can then select building with search functionality then its redirect to create floor plan page.

The user can place different structures, labels, and openings and after clicking over done button floor plan button will be uploaded.

Same as in-building test, user can start the drive test and all slave devices connect to master handset.

Further, the user can select connection mode by click on Bluetooth manager option. At server (master device) different clients (slave devices) can be connect by mutual pairing.

At in-building page user able to see different options and can perform two tests i.e., DL and UL throughput.

The User can then start test when click over play button. Lightening up of icon shows that both client devices are connected properly, and once test started all icons light up (i.e., Bluetooth and warming up icons).

The user can see the connected operator's icons. Test can be performed by putting push pins. The user can pause and stop the test.

Finally, at result page the user can be able to see different operators walk test. At result page, the user can be able to sync all combine drive data to server.

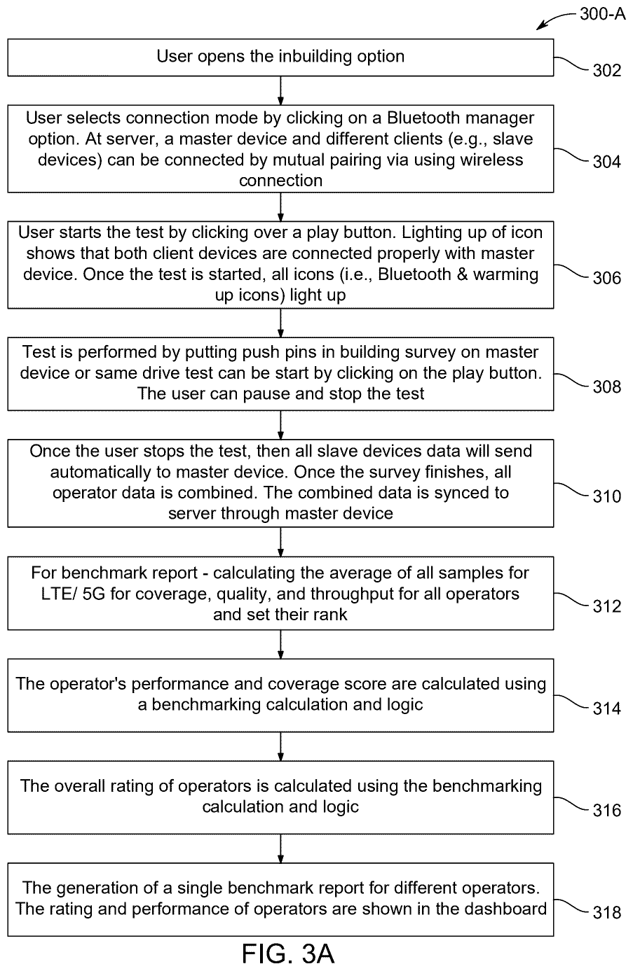

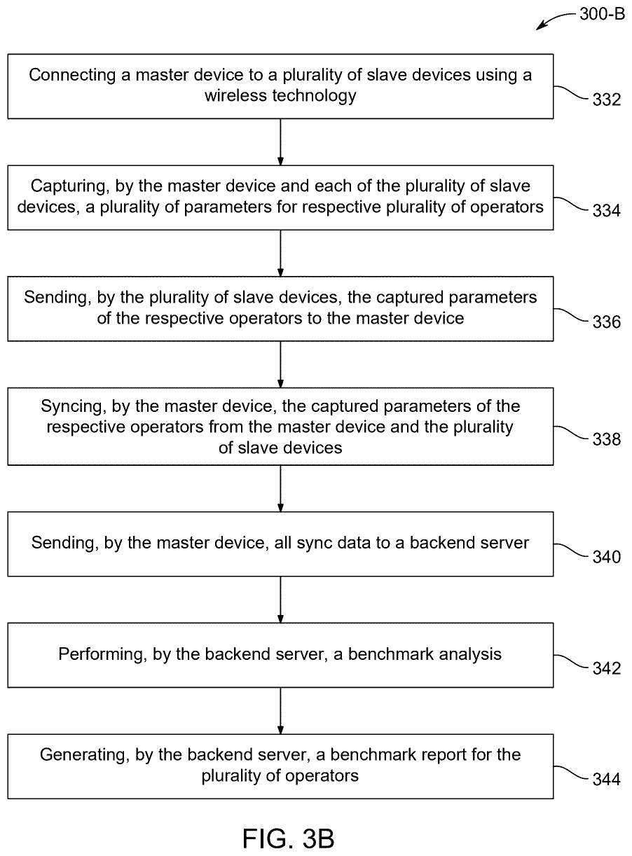

FIG. 3A illustrates an exemplary process flow diagram (300-A) of a method of generating a benchmark report, in accordance with an embodiment of the present disclosure.

As illustrated in FIG. 3A, at step 302, the process starts with the user opening the in-building survey on their device.

At step 304, the user may select the connection mode by clicking on a Bluetooth manager option. At the server, the master device (104) and different clients (e.g., slave devices (106-1, 106-2, 106-3, 106-4, 106-5)) may be connected by mutual pairing via wireless technology such as Bluetooth or Wi-Fi.

At step 306, when the user is ready to start the test, the user clicks on the play button. The icon lights up to indicate that both the client devices (e.g., slave devices) are connected properly with the master device. Once the test is started, all icons light up. The icons include the Bluetooth and warming up icons.

At step 308, the test may be performed by putting push pins in the building survey on the master device, or the same drive test can be started by clicking the play button. The user can pause and stop the test at any time.

At step 310, when the user stops the test, all slave device data is automatically sent to the master device. Once the survey is finished, all operator data is combined. The combined data corresponding to all operators is synced to the server through the master device.

At step 312, for the benchmark report, the average of all samples for LTE/5G coverage, quality, and throughput for all operators is calculated, and their rank is set accordingly.

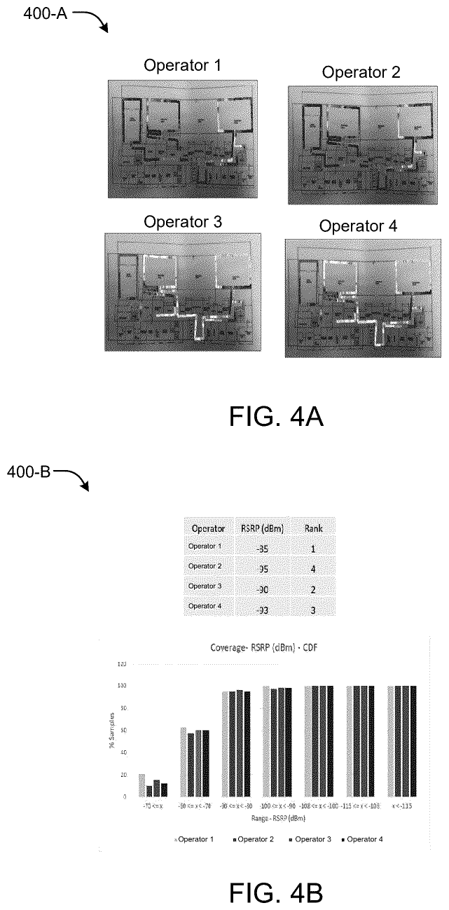

At step 314, the operator's performance and coverage score are calculated using a benchmarking calculation and logic as explained in detail in FIGS. 4A-4B, 5A-5B, 6A-6B. The performance and coverage score are calculated for different operators for networks (e.g., LTE, 5G and LTE+5G).

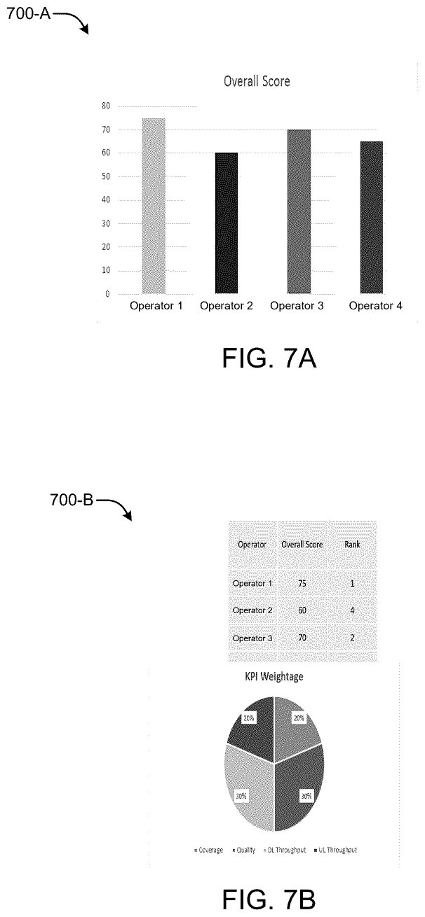

At step 316, the overall rating of operators is calculated using the benchmarking calculation and logic as explained in detail in FIGS. 7A-7B.

At step 318, generation of a single benchmark report for different operators. The rating and performance of operators are shown in the dashboard.

FIG. 3B illustrates an exemplary flow diagram (300-B) of a method for indoor or outdoor benchmarking in a telecommunication network, in accordance with an embodiment of the present disclosure.

As illustrated in FIG. 3B, at step 332, connecting a master device to a plurality of slave devices using a wireless technology. The master device is connected to one of a plurality of operators, and each of the plurality of slave devices are connected to one of remaining other operators of the plurality of operators.

At step 334, capturing, by the master device and each of the plurality of slave devices, a plurality of parameters for respective plurality of operators. For capturing the parameters of respective plurality of operators in indoor benchmarking, a floor plan is created on the master device via an application programming interface (API). A walk test is conducted by selecting a location on the floor plan. The plurality of parameters for respective plurality of operators for the selected location on the floor plan is captured by the master device and the plurality of slave devices. For capturing the parameters of respective plurality of operators in the outdoor benchmarking, a drive test for the outdoor benchmarking is started from a first location to a second location on the master device via the API. A map of the drive test is shown on the master device. The master device and each of the plurality of slave devices capture the plurality of parameters for respective plurality of operators. When the user stops at the second location, the master device receives a plurality of measurements from the plurality of slave devices.

At step 336, sending, by the plurality of slave devices, the captured parameters of the respective operators to the master device.

At step 338, syncing, by the master device, the captured parameters of the respective operators from the master device and the plurality of slave devices.

At step 340, sending, by the master device, all sync data to a backend server.

At step 342, performing, by the backend server, a benchmark analysis. For performing the benchmark analysis, the backend server collects a plurality of samples of the captured parameters for each of the plurality of operators according to a plurality of defined ranges. The backend server calculates average of all the samples of the captured parameters for each of the plurality of operators. The plurality of parameters includes a received signal reference power (RSRP), a signal to interference plus noise ratio (SINR), a throughput for uplink and downlink. The backend server sets a plurality of ranks to the samples of the captured parameters for each of the plurality of operators according to respective strengths. The plurality of ranks includes good, average and bad. A graph of samples of the captured parameters for each of the plurality of operators is plotted according to the rank. A performance score and a coverage score of each of the plurality of operators are calculated. An overall rating of each of the plurality of operators is calculated.

At step 344, a benchmark report is generated for the plurality of operators. The benchmark report is provided in a dashboard.

FIGS. 4A-4B illustrate exemplary graphs and tables for LTE coverage (400-A, 400-B), in accordance with an embodiment of the present disclosure.

The performance and coverage score of different operators in the network are calculated using the benchmarking calculation and logic as explained below:

At the server/report generation side, the benchmarking calculation and logic are the same for both in-building and drive test surveys. The report generation part for DL/UL report for different operators and one combined benchmark report can be developed at the server side using the following logic and calculations.

Showing overall LTE coverage for all 4 operators as follows:

The logic for individual operator is to average all samples (RSRP) and set their rank according to their signal strength. The LTE ranges are shared as a legend, and samples are collected according to those ranges and plotted on a graph.

For example, if the RSRP values range between −60 dBm to −70 dBm, those samples will be in the “Excellent” range, and if they range between −110 dBm to −120 dBm, those samples will be in the “Poor” range. This process is repeated for all operators, and their LTE coverage is calculated and ranked accordingly. Other parameters such as LTE Quality and LTE Throughput are also calculated using similar logic and calculations. Finally, the overall rating of operators is calculated using the same logic and calculations, enabling the generation of a single benchmark report for a single survey for different operators, showing their rating and performance in the dashboard.

Table 1 shows RSRP ranges for LTE.

TABLE 1

| | |
|---|---|
| Range | Color |

| | | |
|---|---|---|
| >−95 | dbm | Grey |

| | |
|---|---|
| >=−110 dbm to <=−95 dbm | White |

| | | |
|---|---|---|
| <−110 | dbm | Black |

Table 2 shows SINR ranges for LTE.

TABLE 2

| | |
|---|---|
| Range | Color |

| | | |
|---|---|---|
| >=5 | db | Grey |

| | |
|---|---|
| >=−2 db to <5 db | White |

| | | |
|---|---|---|
| <−2 | db | Black |

Table 3 shows UL ranges for LTE.

TABLE 3

| | |
|---|---|
| Range | Color |

| | | |
|---|---|---|
| >3 | Mbps | Grey |

| | |
|---|---|
| >0.500 Kbps to <=3 Mbps | White |

| | | |
|---|---|---|
| <0.500 | Kbps | Black |

Table 4 shows DL ranges for LTE.

TABLE 4

| | |
|---|---|
| Range | Color |

| | | |
|---|---|---|
| >32 | Mbps | Grey |

| | |
|---|---|
| >2 Mbps to <=32 Mbps | White |

| | | |
|---|---|---|
| <=2 | Mbps | Black |

In FIG. 4A, an overall LTE coverage for all 4 operators is shown.

In FIG. 4B, the calculated coverage for all 4 operators is shown. Also, ranking is given to all 4 operators based on the coverage. For example, rank of operator 1 is 1, operator 3's rank is 2, operator 4's rank is 3 and operator 2's rank is 4. The graph is showing the coverage (e.g., RSRP) for all the operators.

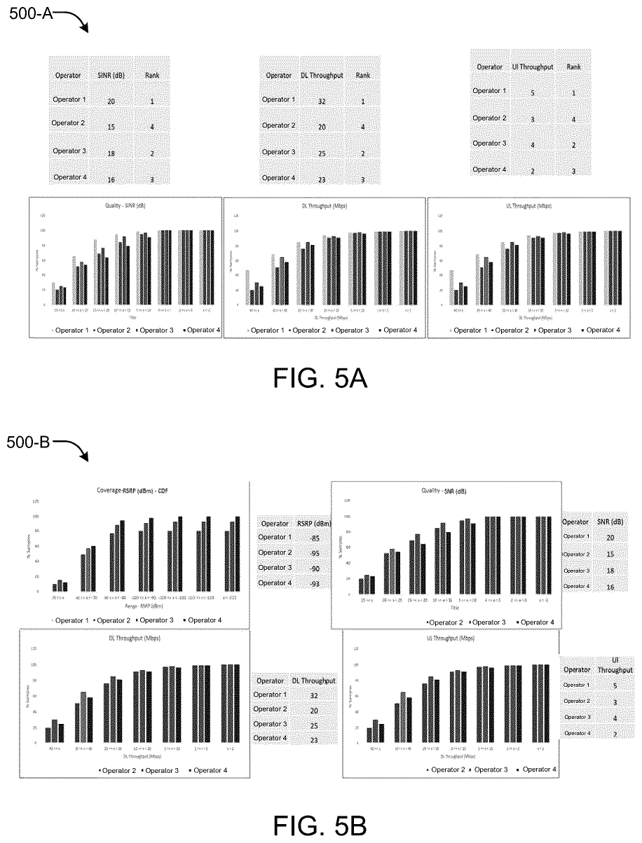

FIG. 5A illustrates exemplary graphs and tables for LTE quality and throughput (500-A) of different operators, in accordance with an embodiment of the present disclosure.

To plot the overall LTE quality (SINR) and throughput (DL/UL), the logic used is to average all samples (SINR) and DL/UL for individual operators. Based on the collective value, the rank of each operator can be set. For example, if the average SINR value for operator A is higher than operator B, then operator A will be ranked higher for LTE Quality. Similarly, if the average DL/UL throughput value for operator C is higher than operator D, then operator C will be ranked higher for LTE throughput. This process is repeated for all operators, and their LTE Quality and throughput are calculated and ranked accordingly.

In FIG. 5A, the 1^{st} graph shows quality of different operators for LTE network. The 1^{st} table shows the quality (e.g., SINR) different operators.

In FIG. 5A, the 2^{nd} graph shows download (DL) throughput of different operators for LTE network. The 2^{nd} table shows the DL throughput of different operators.

In FIG. 5A, the 3^{rd} graph shows the uplink (UL) throughput of different operators for LTE network. The 3rd table shows the UL throughput of different operators.

FIG. 5B illustrates exemplary graphs and tables for 5G network performance (500-B), in accordance with an embodiment of the present disclosure. The same logic and calculations can be used for 5G as well.

By plotting the overall LTE quality and throughput for different operators, the benchmark report can provide a comprehensive view of the network performance, enabling telecom companies to optimize network performance and meet the needs of users.

In FIG. 5B, the 1st graph shows coverage (RSRP) of different operators for 5G network. The 1st table shows the coverage (RSRP) score.

In FIG. 5B, the 2nd graph shows quality of different operators of 5G network. The 2nd table shows quality score of different operators.

In FIG. 5B, the 3rd graph shows downlink (DL) throughput of different operators for 5G network. The 3rd table shows the DL throughput of different operators.

Further, in FIG. 5B, the 4th graph shows uplink (UL) throughput of different operators for 5G network. The 4th table shows the UL throughput of different operators.

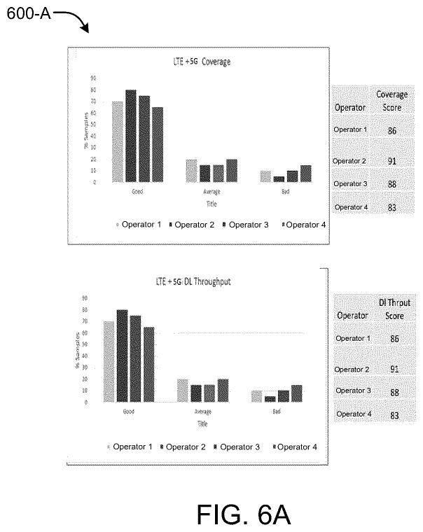

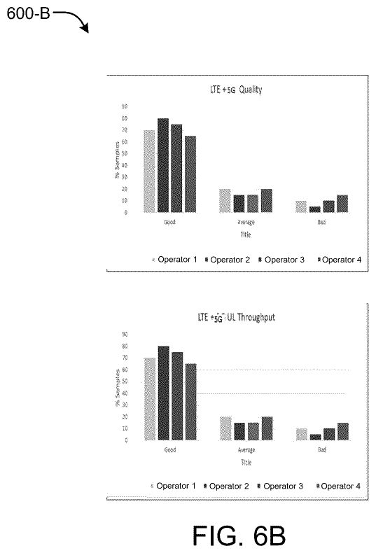

FIG. 6A-6B illustrates exemplary graphs and tables for LTE+5G network performance (600-A, 600-B), in accordance with an embodiment of the present disclosure.

The LTE+5G performance in the benchmark report is presented.

The 1^{st} logic for graph plotting is as follows: suppose one has 100 samples for a walk test, with 50 samples for LTE and 50 samples for 5G. Then, first divide the LTE samples into “Good”, “Average”, and “Bad” buckets based on their ranges, such as signal strength. Let's say one have 20 samples in the “Good” bucket, 20 samples in the “Average” bucket, and 10 samples in the “Bad” bucket.

Then repeat the same process for the 5G samples, with 20 samples in the “Good” bucket, 20 samples in the “Average” bucket, and 10 samples in the “Bad” bucket.

For a particular operator, the Good LTE sample count and the Good 5G sample count are added to get the total count for the “Good” bucket and repeat this process for the “Average” and “Bad” buckets. For example, if the operator 1 has 20 Good LTE samples and 20 Good 5G samples, then add them to get a total of 40 and plot this value in the “Good” bucket. Repeat this process for all operators.

The 2^{nd} logic for the coverage, quality, and throughput score table is as follows: take the final value from the above graph plotting, which is the count of samples in the “Good”, “Average”, and “Bad” sections for each operator. Let's say the count for the coverage is 40 for “Good”, 40 for “Average”, and 20 for “Bad”.

Use the following formula to calculate the coverage score:

$$( 40 \times 5 + 40 \times 3 + 20 \times 2 ) / 5.$$

Repeat this process for the quality and the throughput. Note that for only UL/DL, use the same legends and ranges for both LTE and 5G.

By using these logic and calculations, the benchmark report can provide a comprehensive view of the LTE+5G network performance, enabling telecom companies to optimize network performance and meet the needs of users.

Based on the logic and calculations, FIGS. 6A-6B show the graphs and tables for LTE+5G network performance of different operators (e.g., operator 1, operator 2, operator 3 and operator 4).

In FIG. 6A, 1^{st} graph of coverage of LTE+5G network of different operators is shown. The 1st table shows the coverage score of the operators.

In FIG. 6A, the 2nd graph of DL throughput of LTE+5G network of different operators is shown. The 2nd table shows the DL throughput score of the operators.

In FIG. 6B, 1^{st} graph of quality of LTE+5G network of different operators is shown. 2nd graph of UL throughput of LTE+5G network of different operators is shown.

FIG. 7A-7B illustrates exemplary graph and table for overall rating (700), in accordance with an embodiment of the present disclosure. The overall rating for each operator is shown.

The overall rating of operators is calculated using the benchmarking calculation and logic as explained below:

The logic for calculating the overall rating is to take the final Coverage, Quality, and Throughput score from the previous section. Then, the KPI weightage is applied. The KPI weightage shows that coverage has a weightage of 20%, Quality has a weightage of 30%, DL Throughput has a weightage of 30%, and UL Throughput has a weightage of 20%.

The following formula is used to calculate the overall score for each operator:

$$( 20 \% of Coverage score ) + ( 30 \% of Quality score ) + ( 30 \% of DL Throughput score ) + ( 20 \% of UL Throughput score )$$

By using this formula, one can calculate the overall rating for each operator based on their performance in the Coverage, Quality, DL Throughput, and UL Throughput parameters. For example,
For Operator 1, the Coverage score is 86, the Quality score is 86, the DL Throughput score is 86, and the UL Throughput score is 86.
The overall score for operator 1:

$$( 20 \% * 86 ) + ( 30 \% * 86 ) + ( 30 \% * 86 ) + ( 20 \% * 86 ) = 86$$

The overall rating provides a comprehensive view of the operator's network performance, enabling telecom companies to optimize network performance and meet the needs of users.

In FIG. 7A, the graph is shown for overall coverage of different operators of the network.

In FIG. 7B, the table shows the overall score and the ranking of different operators of the network. KPI weightage for the coverage, the quality, the UL throughput, and the DL throughput. For example, the coverage=20%, the quality=30%, the UL throughput=20%, the DL throughput=30%.

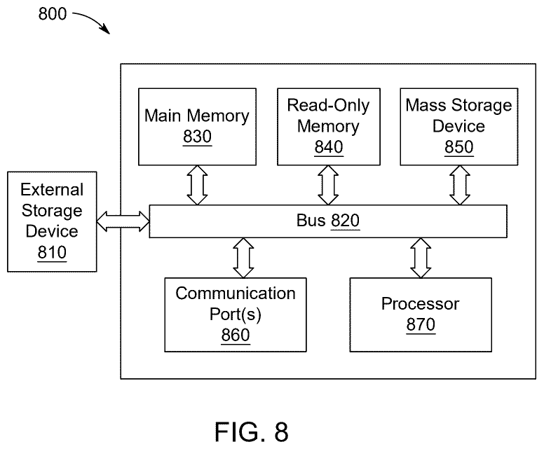

FIG. 8 illustrates an exemplary computer system (800) in which or with which embodiments of the present invention can be utilized.

Referring to FIG. 8, the computer system (800) includes an external storage device (810), a bus (820), a main memory (830), a read only memory (840), a mass storage device (850), communication port (860), and a processor (870). A person skilled in the art will appreciate that computer system may include more than one processor and communication ports. Examples of processor (870) include, but are not limited to, an Intel® Itanium® or Itanium 2 processor(s), or AMD® Opteron® or Athlon MP® processor(s), Motorola® lines of processors, FortisBC™ system on a chip processors or other future processors. Processor (870) may include various modules associated with embodiments of the present invention. Communication port (860) can be any of an RS-232 port for use with a modem-based dialup connection, a 10/100 Ethernet port, a Gigabit or 10 Gigabit port using copper or fiber, a serial port, a parallel port, or other existing or future ports. Communication port (860) may be chosen depending on a network, such a Local Area Network (LAN), Wide Area Network (WAN), or any network to which computer system connects.

In an embodiment, the memory (830) can be Random Access Memory (RAM), or any other dynamic storage device commonly known in the art. Read only memory (840) can be any static storage device(s) e.g., but not limited to, a Programmable Read Only Memory (PROM) chips for storing static information e.g., start-up or BIOS instructions for processor (870). Mass storage (860) may be any current or future mass storage solution, which can be used to store information and/or instructions. Exemplary mass storage solutions include, but are not limited to, Parallel Advanced Technology Attachment (PATA) or Serial Advanced Technology Attachment (SATA) hard disk drives or solid-state drives (internal or external, e.g., having Universal Serial Bus (USB) and/or Firewire interfaces), e.g. those available from Seagate (e.g., the Seagate Barracuda 7102 family) or Hitachi (e.g., the Hitachi Deskstar 7K1000), one or more optical discs, Redundant Array of Independent Disks (RAID) storage, e.g. an array of disks (e.g., SATA arrays), available from various vendors including Dot Hill Systems Corp., LaCie, Nesan Technologies, Inc. and Enhance Technology, Inc.

In an embodiment, the bus (820) may communicatively couple processor(s) (870) with the other memory, storage and communication blocks. Bus (820) can be, e.g. a Peripheral Component Interconnect (PCI)/PCI Extended (PCI-X) bus, Small Computer System Interface (SCSI), USB or the like, for connecting expansion cards, drives and other subsystems as well as other buses, such a front side bus (FSB), which connects processor (870) to software system.

In another embodiment, operator and administrative interfaces, e.g., a display, keyboard, and a cursor control device, may also be coupled to bus (820) to support direct operator interaction with computer system. Other operator and administrative interfaces can be provided through network connections connected through communication port (860). External storage device (810) can be any kind of external hard-drives, floppy drives, IOMEGA® Zip Drives, Compact Disc-Read Only Memory (CD-ROM), Compact Disc-Re-Writable (CD-RW), Digital Video Disk-Read Only Memory (DVD-ROM). Components described above are meant only to exemplify various possibilities. In no way should the aforementioned exemplary computer system limit the scope of the present disclosure.

While considerable emphasis has been placed herein on the preferred embodiments, it will be appreciated that many embodiments can be made and that many changes can be made in the preferred embodiments without departing from the principles of the disclosure. These and other changes in the preferred embodiments of the disclosure will be apparent to those skilled in the art from the disclosure herein, whereby it is to be distinctly understood that the foregoing descriptive matter to be implemented merely as illustrative of the disclosure and not as limitation.

### ADVANTAGES OF THE PRESENT DISCLOSURE

The present disclosure is capable of performing large survey tests for both indoor and outdoor environments with a single handset, providing accurate network KPI measurements for all operators on a single cycle. This reduces the need for multiple devices and saves time and costs associated with benchmarking walk tests and drive tests.

The present disclosure helps organizations reduce operation costs and increase the accuracy of benchmarking by automating the process of data collection and analysis. This saves approximately 18-20 man-hours per 3 operator benchmarking cycle.

The present disclosure generates a single benchmark report for all operators, saving time, costs, and engineer efforts. The report can be visualized on the survey dashboard, providing a comprehensive view of operators' network performance.

The present disclosure uses wireless technology, such as Bluetooth or Wi-Fi, to connect multiple devices and sync data from a single master device. This automates the solution, reducing the need for manual data collection and analysis.

The present disclosure calculates operators' performance and their coverage score, providing a comprehensive view of their network performance.

This enables telecom companies to optimize network performance and meet the needs of users.

The present disclosure calculates operators' overall rating, providing a comprehensive view of their network performance based on their coverage, quality, and throughput. This enables telecom companies to optimize network performance and meet the needs of users while reducing costs and time associated with benchmarking.

The present disclosure provides a more accurate and comprehensive view of network performance, as it measures network KPIs for all operators on a single cycle. This enables telecom companies to identify network issues and optimize network performance to meet the needs of users.

The present disclosure is user-friendly and easy to use, as it requires only a single handset and automates the data collection and analysis process. This reduces the need for manual intervention and saves time and costs associated with benchmarking.

The present disclosure allows for real-time monitoring and analysis of network performance, as the survey dashboard provides a live view of network KPIs. This enables telecom companies to identify and address network issues in real-time, improving the user experience.

The present disclosure is scalable and can be used for benchmarking in different environments, including indoor and outdoor environments. This makes it suitable for telecom companies operating in different regions and serving different user needs.

The present disclosure is cost-effective, as it reduces the need for multiple devices and manual data collection and analysis. This saves costs associated with benchmarking and enables telecom companies to optimize network performance with minimal investment.

We claim:

1. A method for indoor or outdoor benchmarking in a telecommunication network (100), the method comprising:
connecting a master device (104) to a plurality of slave devices (106-1, 106-2, 106-3, 106-4, 106-5) using a wireless technology, wherein the master device (104) is connected to one of a plurality of operators, and each of the plurality of slave devices (106-1, 106-2, 106-3, 106-4, 106-5) are connected to one of remaining other operators of the plurality of operators;
capturing, by the master device (104) and each of the plurality of slave devices (106-1, 106-2, 106-3, 106-4, 106-5), a plurality of parameters for respective plurality of operators;
sending, by the plurality of slave devices (106-1, 106-2, 106-3, 106-4, 106-5), the captured parameters of the respective operators to the master device (104);
syncing, by the master device (104), the captured parameters of the respective operators from the master device (104) and the plurality of slave devices (106-1, 106-2, 106-3, 106-4, 106-5);
sending, by the master device, all sync data to a backend server (102);
performing, by the backend server (102), a benchmark analysis; and
generating, by the backend server (102), a benchmark report for the plurality of operators.

2. The method claimed as in claim 1, wherein for capturing the plurality of parameters of respective plurality of operators in indoor benchmarking:
creating, by a user, a floor plan on the master device (104) via an application programming interface (API);
conducting, by the user, a walk test by selecting a location on the floor plan; and
capturing, by the master device (104) and the plurality of slave devices (106-1, 106-2, 106-3, 106-4, 106-5), the plurality of parameters for respective plurality of operators for the selected location on the floor plan.

3. The method claimed as in claim 1, wherein for capturing the plurality of parameters of respective plurality of operators in the outdoor benchmarking:
starting, by the user, a drive test for the outdoor benchmarking from a first location to a second location on the master device (104) via the API, wherein a map of the drive test is shown on the master device (104);
capturing, by the master device (104) and each of the plurality of slave devices (106-1, 106-2, 106-3, 106-4, 106-5), the plurality of parameters for respective plurality of operators; and
when the user stops at the second location, receiving, by the master device, a plurality of measurements from the plurality of slave devices (106-1, 106-2, 106-3, 106-4, 106-5).

4. The method claimed as in claim 1, wherein for performing the benchmark analysis:
collecting, by the backend server (102), a plurality of samples of the captured parameters for each of the plurality of operators according to a plurality of defined ranges;
calculating, by the backend server (102), average of all the samples of the captured parameters for each of the plurality of operators, wherein the plurality of parameters includes a received signal reference power (RSRP), a signal to interference plus noise ratio (SINR), a throughput for uplink and downlink;
setting, by the backend server (102), a plurality of ranks to the samples of the captured parameters for each of the plurality of operators according to respective strengths, wherein the plurality of ranks includes good, average and bad;
plotting, by the backend server (102), a graph of samples of the captured parameters for each of the plurality of operators according to the rank;
calculating, by the backend server (102), a performance score and a coverage score of each of the plurality of operators;
calculating, by the backend server (102), an overall rating of each of the plurality of operators; and
generating, by the backend server (102), the benchmark report for the plurality of operators.

5. The method claimed as in claim 1, wherein the benchmark report is provided in a dashboard.

6. A system for indoor or outdoor benchmarking in a telecommunication network (100), the system comprising a master device (104), a plurality of slave devices (106-1, 106-2, 106-3, 106-4, 106-5) and a backend server (102),
the master device (104) configured to connect with the plurality of slave devices (106-1, 106-2, 106-3, 106-4, 106-5) using a wireless technology, wherein the master device (104) is connected to one of plurality of operators and each of the plurality of slave devices (106-1, 106-2, 106-3, 106-4, 106-5) is connected to one of remaining other operators of the plurality of operators;
the master device (104) and each of the plurality of slave devices (106-1, 106-2, 106-3, 106-4, 106-5) configured to capture a plurality of parameters for the respective plurality of operators; and
the master device (104) comprising:
a receiving module (104-4) configured to receive the captured parameters of the respective operators from the plurality of slave devices (106-1, 106-2, 106-3, 106-4, 106-5);
a processing module (104-6) configured to sync the captured parameters of the respective operators from the master device (104) and the plurality of slave devices (106-1, 106-2, 106-3, 106-4, 106-5); and
a sending module (104-8) configured to send all sync data to the backend server (102);
the backend server (102) comprising:
an analyzing module (102-1) configured to perform a benchmark analysis; and
a generating module (102-2) configured to generate a benchmark report for the plurality of operators.

7. The system claimed as in claim 6, wherein for capturing the plurality of parameters of respective plurality of operators in an indoor benchmarking:
the master device (104) configured to create a floor plan via an application programming interface (API);
the master device (104) configured to conduct a walk test by selecting a location on the floor plan; and
the master device (104) and each of the plurality of slave devices (106-1, 106-2, 106-3, 106-4, 106-5) configured to capture the plurality of parameters for respective plurality of operators for the selected location on the floor plan.

8. The system claimed as in claim 6, wherein for capturing the plurality of parameters of respective plurality of operators in the outdoor benchmarking:
the master device (104) configured to start a drive test for the outdoor benchmarking from a first location to a second location via the API, wherein a map of the drive test is shown on the master device (104);
the master device (104) and the plurality of slave devices (106-1, 106-2, 106-3, 106-4, 106-5) configured to capture the plurality of parameters for the respective plurality of operators; and
when the user stops at the second location, the master device (104) configured to receive a plurality of measurements from the plurality of slave devices (106-1, 106-2, 106-3, 106-4, 106-5).

9. The system claimed as in claim 6, wherein for performing the benchmark analysis the backend server (102) comprising:
a collection module (102-4) configured to collect a plurality of samples of the captured parameters for each of the plurality of operators according to a plurality of defined ranges;
a calculation module (102-3) configured to calculate average of all the samples of the captured parameters for each of the plurality of operators, wherein the plurality of parameters includes a received signal reference power (RSRP), a signal to interference plus noise ratio (SINR), a throughput for uplink and downlink;
the processing module (102-5) configured to set a plurality of ranks to the samples of the captured parameters for each of the plurality of operators according to respective strengths, wherein the plurality of ranks includes good, average and bad;
the processing module (102-5) configured to plot a graph of samples of the captured parameters for each of the plurality of operators according to the rank;
the calculation module (102-3) configured to calculate a performance score and a coverage score of each of the plurality of operators;
the calculation module (102-3) configured to calculate an overall rating of each of the plurality of operators; and
the generating module (102-2) configured to generate the benchmark report for the plurality of operators.

10. The system claimed as in claim 6, wherein the benchmark report is provided in a dashboard.

11. A master device (104) for indoor or outdoor benchmarking in a telecommunication network (100), the master device (104) configured to:
connect with plurality of slave devices (106-1, 106-2, 106-3, 106-4, 106-5) using a wireless technology, wherein the master device (104) is connected to one of the plurality of operators and each of the plurality of slave devices (106-1, 106-2, 106-3, 106-4, 106-5) is connected to one of remaining other operators of the plurality of operators;
capture a plurality of parameters for the respective plurality of operators, wherein each of the plurality of slave devices (106-1, 106-2, 106-3, 106-4, 106-5) configured to capture the plurality of parameters for the respective plurality of operators;
receive the captured parameters of the respective operators from the plurality of slave devices (106-1, 106-2, 106-3, 106-4, 106-5);
sync the captured parameters of the respective operators from the master device and the plurality of slave devices (106-1, 106-2, 106-3, 106-4, 106-5), wherein the master device (104) and the plurality of slave devices (106-1, 106-2, 106-3, 106-4, 106-5) are user equipments; and
send all sync data to a backend server (102), wherein the backend server configured to generate a benchmark report for the plurality of operators by performing a benchmark analysis.

12. The master device (104) claimed as in claim 11, wherein the master device (104) for capturing the plurality of parameters of respective plurality of operators in the outdoor benchmarking further configured to:
create a floor plan via an application programming interface (API);
conduct a walk test by selecting a location on the floor plan; and
capture the plurality of parameters for respective plurality of operators for the selected location on the floor plan, wherein each of the plurality of slave devices (106-1, 106-2, 106-3, 106-4, 106-5) configured to capture the plurality of parameters for respective plurality of operators for the selected location on the floor plan.

13. The master device (104) claimed as in claim 11, wherein the master device (104) for capturing the plurality of parameters of respective plurality of operators in the outdoor benchmarking further configured to:
start a drive test for the outdoor benchmarking from a first location to a second location via the API, wherein the master device configured to show a map of the drive test;
capture the plurality of parameters for the respective plurality of operators; and
receive a plurality of measurements from the plurality of slave devices (106-1, 106-2, 106-3, 106-4, 106-5), when the user stops at the second location.

14. The master device (104) claimed as in claim 11, wherein for performing the benchmark analysis, the backend server (102) configured to:
collect a plurality of samples of the captured parameters for each of the plurality of operators according to a plurality of defined ranges;
calculate average of all the samples of the captured parameters for each of the plurality of operators, wherein the plurality of parameters includes a received signal reference power (RSRP), a signal to interference plus noise ratio (SINR), a throughput for uplink and downlink;
set a plurality of ranks to the samples of the captured parameters for each of the plurality of operators according to respective strengths, wherein the plurality of ranks includes good, average and bad;
plot a graph of samples of the captured parameters for each of the plurality of operators according to a rank;
calculate a performance score and a coverage score of each of the plurality of operators;
calculate an overall rating of each of the plurality of operators; and
generate the benchmark report for the plurality of operators.

15. The master device (104) claimed as in claim 11, wherein the benchmark report is provided in a dashboard.

16. A computer program product comprising a non-transitory computer-readable medium comprising instructions that, when executed by one or more processors, cause the one or more processors to perform a method for indoor or outdoor benchmarking in a telecommunication network, the method comprising:
connecting a master device (104) to a plurality of slave devices (106-1, 106-2, 106-3, 106-4, 106-5) using a wireless technology, wherein the master device (104) is connected to one of a plurality of operators, and each of the plurality of slave devices (106-1, 106-2, 106-3, 106-4, 106-5) are connected to one of remaining other operators of the plurality of operators;
capturing, by the master device (104) and each of the plurality of slave devices (106-1, 106-2, 106-3, 106-4, 106-5), a plurality of parameters for respective plurality of operators;
sending, by the plurality of slave devices (106-1, 106-2, 106-3, 106-4, 106-5), the captured parameters of the respective operators to the master device (104);
syncing, by the master device (104), the captured parameters of the respective operators from the master device and the plurality of slave devices (106-1, 106-2, 106-3, 106-4, 106-5);
sending, by the master device (104), all sync data to a backend server (102);
performing, by the backend server (102), a benchmark analysis; and
generating, by the backend server (102), a benchmark report for the plurality of operators.
